(19) United States
(12) Patent Application Publication
(10) Pub. No.: US 2004/0043092 A1
(43) Pub. Date: Mar. 4, 2004

(54) Injection molding device with at least two controls

(76) Inventors: Oswald Dachs, Eckental (DE); Andreas Melkus, Oberndorf (AT); Gerd Warnecke, Naumburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/399,437

(22) PCT Filed: Oct. 17, 2001
(86) PCT No.: PCT/DE01/03958

(30) Foreign Application Priority Data
Oct. 18, 2000 (DE) 100 52 996.8

(51) Int. Cl. B29C 45/76

(52) U.S. Cl. 425/162; 425/169

(57) ABSTRACT

The invention relates to an injection molding device, in particular for plastics, with at least two controls, which are connected to data display units via data display lines. In this case, the individual data display lines (51-53) have controllable switches (21-23), and also a control device (31) for controlling the switches (21-23), the switches (21-23) being connected in the closed state to a main data line (55), which lead to a common data display unit (11).

The invention relates to an injection molding device, in particular for plastics, with at least two controls, which are connected to data display units via data display lines.

EP 0 199 823 B1 discloses a control device comprising a display unit of an injection molding machine, which device displays different states of the machine on a screen of a display unit. Only data of the single injection molding machine connected to the display unit are processed.

WO 00/08606 discloses an injection molding machine with an operator control device which has a touch screen, on which a receiving device which receives an identification code in a contactless manner is assigned.

This touch screen is connected to a single injection molding machine.

In previously known configurations of injection molding machines, where extended peripheral controls are also interconnected in addition to the machine control, each control has in each case an assigned data display unit. In addition to the high space requirement of the individual data display units, it is onerous for the operator to register centrally the display at a given time of all the important data of the individual machines.

The invention is therefore based on the object of providing a device and a method which ensures the input and monitoring of setting data on controls of injection molding machines reliably, clearly and especially conveniently for the operator.

The invention achieves this object by the features of the device claim 1 and the method claim 5.

According to the invention, the individual data display lines have controllable switches, which can be controlled by means of a control device. In the closed state, the individual control data are displayed on a central data display unit. Apart from the machine control, peripheral controls such as that of the handling equipment, hot runner device, temperature control units and similar units are included in the input and monitoring of the setting data on injection molding machines.

According to the method, there are predetermined selection criteria by which the display data are selected and activated and displayed on a single data display unit.

The up-to-dateness of the display data and the degree of change of the individual operating data are used as selection criteria.

The reduction to only one data display unit with selection of the displayed data from the various controls brings about a previously unencountered overall clarity, special convenience for the operator and particularly high reliability when operating injection molding machines.

Furthermore, this type of configuration eliminates the necessity for the programmer for a networking interconnection. This applies in particular in the ever recurring case of extensions created by additional interfaces, which can be easily carried out without great expenditure.

In an advantageous development of the invention it is proposed to carry out the activation of the individual computers and retrieval of the corresponding data via a touch screen. After touching the screen, this command goes to the corresponding hardware switch, which connects the data display lines to the computer called up.

In a further advantageous configuration, a printer is connected to the data display unit. This printer has a memory for rapidly recording selected data. These individual data can be prepared at a given time independently of the data display unit and be printed out.

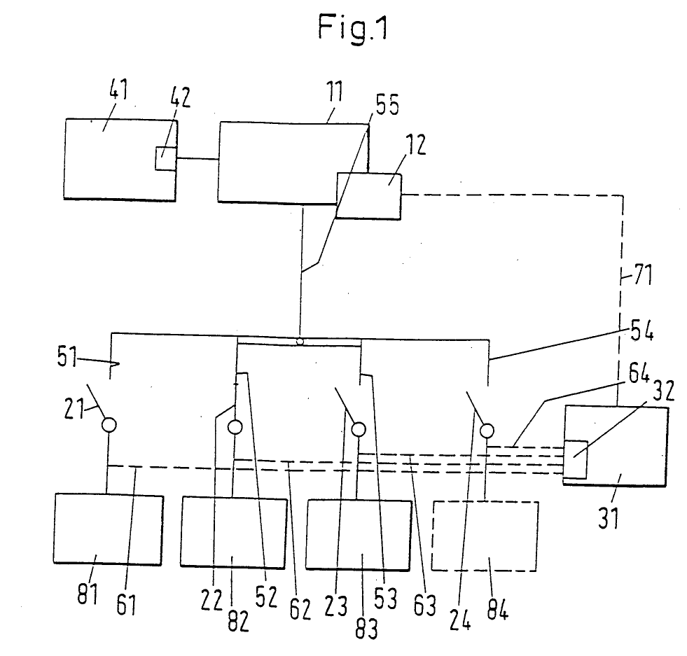

An example of the invention is presented in the accompanying drawing. In it, FIG. 1 shows a data display unit 11, that is connected to a control device 31 via a data line 71. In the present case, the data display unit has a touch-screen functional unit 12.

The control device 31 has a control element 32, which are connected via control lines 61-64 to switches 21-23 and also a possible switch extension or a reserve switch 24.

The switches 21-24 are arranged in data display lines 51-54, which are connected at one end to a machine control 81, a hot runner control 82, a hot runner control 83 and a temperature control unit control 84 and are connected at the other end to a main data line 55. The main data line 55 is in direct connection with the data display unit 11.

Connected to the data display unit 11 is a printer 41, which has a memory unit 42, in which the data to be printed later are stored.

List of Items

Data Display

11 data display unit

13 touch-screen functional unit

Switch Units

21-23 switches

24 reserve switch

Controls

31 control device

32 control element

Documentation

41 printer

42 memory unit

Power Lines

51-54 data display line

55 main data line

Control

61-64 control lines

Connecting Unit

71 data line

Controls

81 machine control

82 hot runner control

83 hot runner control

84 temperature control unit control

1. An injection molding device, in particular for plastics, with at least two controls, which are connected to data display units via data display lines, characterized in that the individual data display lines (51-53) have controllable switches (21-23), in that a control device (31) is provided for controlling the switches (21-23), and in that the switches (21-23) are connected in the closed state to a main data line (55), which lead to a common data display unit (11).

2. The injection molding device as claimed in claim 1, characterized in that the data display unit (11) is a screen, which has a touch-screen functional unit (12) with which the switches (21-23) can be controlled.

3. The injection molding device as claimed in claim 1, characterized in that the control device (31) is constructed in such a way that a later extension by adding at least one additional switch (24) is possible.

4. The injection molding device as claimed in one of the preceding claims, characterized in that the control device (31) has elements (32) which ensures via control line (61-64) connected to the switches (21-24) a defined assignment of the controls to the data display unit (11).

5. The injection molding device as claimed in claim 1, characterized in that a printer (41) which has a memory unit (42) for the defined recording of data can be connected to the data display unit (11).

6. A method for the input and monitoring of setting data of an injection molding device corresponding to claim 1, characterized in that the display data are selected according to a defined selection criterion and activated and displayed on a single data display unit.

7. The method as claimed in claim 6, characterized in that the up-to-dateness of the operating data is used as a selection criterion for the displaying of the display data.

8. The method as claimed in claim 6, characterized in that the gradient of change of the operating data is used as a selection criterion for the displaying of the display data.
